(19) United States
(12) Patent Application Publication
(10) Pub. No.: US 2020/0074859 A1
(43) Pub. Date: Mar. 5, 2020

(54) PARKING SYSTEM

(71) Applicant: TOYOTA JIDOSHA KABUSHIKI KAISHA, Toyota-shi (JP)

(72) Inventor: Kazuhito ESHIMA, Fuji-shi (JP)

(73) Assignee: TOYOTA JIDOSHA KABUSHIKI KAISHA, Toyota-shi (JP)

(21) Appl. No.: 16/552,078

(22) Filed: Aug. 27, 2019

(30) Foreign Application Priority Data
Aug. 28, 2018 (JP) 2018-159438

(51) Int. Cl. G08G 1/14; E04H 6/42

(52) U.S. Cl. CPC G08G 1/149; G05D 1/0212; E04H 6/422; G08G 1/146

(57) ABSTRACT

A parking system is configured to manage driving of an autonomous vehicle in a parking lot, which has a parking section including a plurality of parking spaces and runways for vehicle passage. The parking system is provided with: an acquirer configured to obtain route information indicating a route on which the autonomous vehicle travels in the parking lot; and an effect applier configured to apply a visual effect to at least a part of the runways so as to visually distinguish between a part of the runways corresponding to the route indicated by the route information and the other part of the runways other than the corresponding part, on the basis of the route information.

### CROSS-REFERENCE TO RELATED APPLICATIONS

This application is based upon and claims the benefit of priority of the prior Japanese Patent Application No. 2018-159438, filed on Aug. 28, 2018, the entire contents of which are incorporated herein by reference.

### BACKGROUND

### 1. Technical Field

Embodiments of the present disclosure relate to a parking system configured to manage a parking lot for autonomous vehicles.

### 2. Description of the Related Art

In a parking lot to which this type of system is applied, in order to inform a surrounding human or another vehicle that an autonomous vehicle is autonomously driving, there is proposed a technology/technique in which a horn of the autonomous vehicle is sounded or blinking a hazard lamp (refer to International Publication No. WO2016/066349 (Patent Literature 1)).

By the way, even if the parking lot for autonomous vehicles (hereinafter referred to as an “automated valet parking lot” as occasion demands) is developed, the automated valet parking lot is rarely used without the spread of the autonomous vehicles. Then, for example, financially, it is likely hard to maintain the automated valet parking lot. On the other hand, for example, it is also possible to establish a parking lot for manual vehicles whose parking is performed by a driver's operation, together with the automated valet parking lot, and to integrally manage both the parking lots. In this case, measures for securing the safety of the users are required because a general user may enter the automated valet parking lot.

As one of the measures, the technology/technique described in the Patent Literature 1 can be used. In the technology/technique described in the Patent Literature 1, however, the surrounding human is informed that the autonomous vehicle is autonomously driving, but not is informed of a future behavior of the autonomous vehicle, so that the surrounding human may feel anxiety, which is technically problematic.

### SUMMARY

In view of the aforementioned problem, it is therefore an object of embodiments of the present disclosure to provide a parking system that can suppress the anxiety of a human around a running autonomous vehicle.

The above object of embodiments of the present disclosure can be achieved by a parking system configured to manage driving of an autonomous vehicle in a parking lot, which has a parking section including a plurality of parking spaces and runways for vehicle passage, the parking system provided with: an acquirer configured to obtain route information indicating a route on which the autonomous vehicle travels in the parking lot; and an effect applier configured to apply a visual effect to at least a part of the runways so as to visually distinguish between a part of the runways corresponding to the route indicated by the route information and the other part of the runways other than the corresponding part, on the basis of the route information.

### BRIEF DESCRIPTION OF THE DRAWINGS

FIG. 1 is a block diagram illustrating a configuration of a valet parking apparatus according to an embodiment;

FIG. 2 is a flowchart illustrating a flow of operations of the valet parking apparatus according to the embodiment; and

FIG. 3 is a diagram illustrating a specific example of the operations of the valet parking apparatus according to the embodiment.

### DETAILED DESCRIPTION OF THE EMBODIMENT

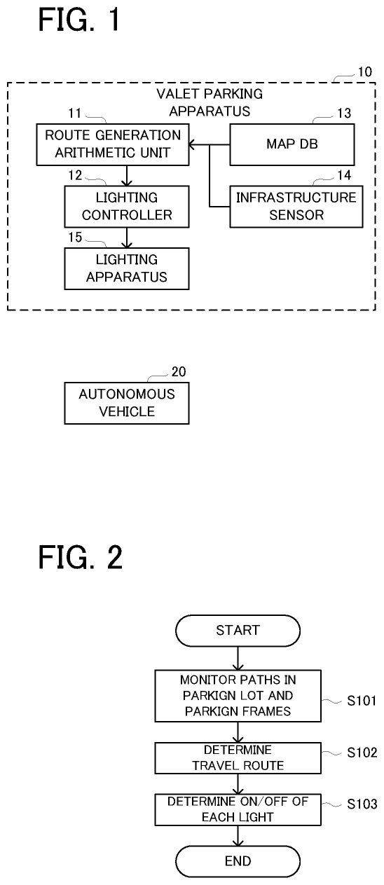

A parking system according to an embodiment of the present disclosure will be explained with reference to FIG. 1 to FIG. 3. In the embodiment below, an example of the parking system is a valet parking apparatus 10.

(Configuration)

A configuration of the valet parking apparatus 10 according the embodiment will be explained with reference to FIG. 1. FIG. 1 is a block diagram illustrating the configuration of the valet parking apparatus 10 according to the embodiment.

Here, the valet parking apparatus 10 may be installed in an automated valet parking lot, and is configured to manage the driving of an autonomous vehicle 20 in the automated valet parking lot. The automated valet parking may have a parking section including a plurality of parking frames (i.e., parking spaces), and runways for vehicle passage to access the parking section (i.e., a road inside the parking lot). Moreover, the automated valet parking lot shall be provided for a parking lot for manual vehicles whose parking is performed by a driver's operation.

In FIG. 1, the valet parking apparatus 10 is provided with a route generation arithmetic unit 11, a lighting controller 12, a map database 13 (hereinafter written as a “map DB” as occasion demands), an infrastructure sensor 14, and a lighting apparatus 15.

The map DB 13 is configured to store therein map information about the automated valet parking lot. The infrastructure sensor 14 may be provided, for example, with a camera, a laser sensor, or the like. The infrastructure sensor 14 is configured to detect a pedestrian and the autonomous vehicle 20 that are in the automated valet parking lot, and an occupied/unoccupied state of each parking frame (in other words, whether or not there is a parking vehicle in each parking frame), for example, on the basis of images of the automated valet parking lot photographed/recorded by the camera, results of measurement of the automated valet parking lot performed by the laser sensor, or the like. As described above, the automated valet parking lot is provided for the parking lot for manual vehicles, and a general user may enter the automated valet parking lot. This is why the pedestrian is detected by the infrastructure sensor 14.

The route generation arithmetic unit 11 is configured to arithmetically operate a travel route to be taken by the autonomous vehicle 20 that is to be parked in the automated valet parking lot or that is to exit from the automated valet parking lot, on the basis of the map information stored in the map DB and detection results of the infrastructure sensor 14. The route generation arithmetic unit 11 is configured to transmit information indicating the arithmetically operated travel route, to the lighting controller 12 and the autonomous vehicle 20 of interest. A detailed explanation of a method of arithmetically operating the travel route will be omitted because various existing methods can be applied to the method.

The lighting apparatus 15 may be provided with a plurality of illumination lights. The plurality of illumination lights are arranged along the runways in the automated valet parking lot. The lighting controller 12 is configured to control the ON/OFF (i.e., turn on/turn off) of each of the plurality of illumination lights. The lighting controller 12 is particularly configured to determine the ON/OFF of each of the plurality of illumination lights, which are provided for the lighting apparatus 15, so that a part of the runways in the automated valet parking lot corresponding to the travel route is illuminated and the other part other than the corresponding part is not illuminated, on the basis of the travel route indicated by the information transmitted from the route generation arithmetic unit 11.

(Operations)

Next, operations of the valet parking apparatus 10 will be explained with reference to a flowchart in FIG. 2.

In FIG. 2, the valet parking apparatus 10 monitors the runways in the automated valet parking lot (i.e., the road inside the parking lot) and the parking frames, on the basis of the detection results of the infrastructure sensor 14 (step S101). In other words, in the step S101, the pedestrian and the autonomous vehicle 20 that are in the automated valet parking lot and the occupied/unoccupied state of each parking frame are monitored.

In the step S101, if at least one of the autonomous vehicle 20 whose parking is newly desired and the autonomous vehicle 20 that is to exit is detected, the route generation arithmetic unit 11 arithmetically operates a travel route on the basis of the map information stored in the map DB 13 and the detection results of the infrastructure sensor 14 (step S102). Specifically, if the autonomous vehicle 20 whose parking is newly desired is detected, the route generation arithmetic unit 11 may determine a parking frame in which the autonomous vehicle 20 is to be parked, and may arithmetically operate a travel route to be taken by the autonomous vehicle 20 until reaching the determined parking frame, on the basis of the detection results of the infrastructure sensor 14. On the other hand, if the autonomous vehicle 20 that is to newly exit is detected, the route generation arithmetic unit 11 may determine a travel route to be taken by the autonomous vehicle 20 until reaching a place to which the autonomous vehicle 20 is to move (e.g., an exit gate in the automated valet parking, etc.), on the basis of the detection results of the infrastructure sensor 14. A detailed explanation of a method of detecting the autonomous vehicle 20 whose parking is newly desired and the autonomous vehicle 20 that is to exit will be omitted because various existing technologies/techniques can be applied to the method.

After the step S102, the route generation arithmetic unit 11 may transmit the information indicating the arithmetically operated travel route, to the lighting controller 12 and the autonomous vehicle 20 of interest (i.e., the autonomous vehicle 20 whose parking is newly desired and the autonomous vehicle 20 that is to exit). The lighting controller 12 determines the ON/OFF of each of the plurality of illumination lights, which are provided for the lighting apparatus 15, so that a part of the runways in the automated valet parking lot corresponding to the travel route is illuminated and the other part other than the corresponding part is not illuminated, on the basis of the travel route indicated by the information transmitted from the route generation arithmetic unit 11 (step S103).

In the step S101, if no pedestrian is detected, the aforementioned process may be ended. In this case, the step S101 may be performed again after a lapse of a predetermined time (e.g., several ten to several hundred seconds). If the automated valet parking is provided with a pedestrian passage and if the lighting apparatus 15 has lights for pedestrians configured to illuminate the pedestrian passage, the lighting controller 12 may turn on the lights for pedestrians in the step S103.

### Technical Effect

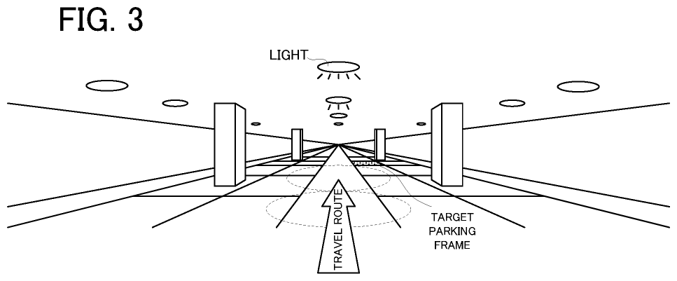

For example, if the autonomous vehicle 20 whose parking is newly desired is detected and if a series of the steps illustrated in the flowchart in FIG. 2 is performed, then, the illumination lights that illuminate a part of the runways corresponding to the travel route (which is herein a travel route to be taken by the autonomous vehicle 20 until reaching a target parking frame) are turned on, for example, as illustrated in FIG. 3. As a result, at least a portion of the corresponding part is illuminated with light from the illumination lights (refer to dashed circles in FIG. 3). On the other hand, the illumination lights that illuminate the other part of the runways other than the corresponding part are turned off. In other words, as a result of the series of the steps illustrated in the flowchart in FIG. 2, the part corresponding to the travel route of the autonomous vehicle 20 is visually distinguished from the other part. Thus, the pedestrian who is in the automated valet parking lot (in other words, the pedestrian who is around the traveling autonomous vehicle 20) can relatively easily recognize the travel route (i.e., a future behavior) of the autonomous vehicle 20. Therefore, according to the valet parking apparatus 10, it is possible to suppress the anxiety of the pedestrian who is around the traveling autonomous vehicle 20. Moreover, since the corresponding part is illuminated with the illumination lights, the pedestrian can relatively easily recognize the traveling autonomous vehicle 20. It can be thus expected that the pedestrian does not carelessly approach the traveling autonomous vehicle 20.

In addition, since the illumination lights that illuminate the part of the runways corresponding to the travel route are turned on, it can be expected, for example, that obstacle recognition using an image sensor, which is provided for the autonomous vehicle 20, can be appropriately performed. It can be thus expected that the autonomous vehicle 20 appropriately drives in the automated valet parking lot. Therefore, according to the valet parking apparatus 10, it is possible to prevent, for example, a contact and a collision between the autonomous vehicle 20 that drives on the travel route and a pedestrian or a parking vehicle or the like.

In the valet parking apparatus 10, the part corresponding to the travel route of the autonomous vehicle 20 and the other part are visually distinguished by switching between the ON/OFF of the illumination lights. Since ON/OFF mechanisms of the illumination lights are generally widely spread, it is possible to reduce a cost for the lighting apparatus 15. In addition, if the valet parking apparatus 10 is introduced in the existing parking lot, it is possible to reduce a repair cost for the parking lot.

FIG. 3 exemplifies a parking lot with a roof, such as, for example, a multistory parking space, but the present disclosure is not limited thereto.

### Modified Examples

Modified examples of the lighting controller 12 and the lighting apparatus 15 will be explained below.
(1) The lighting apparatus 15 may have a plurality of illumination lights, each of which can change illumination intensity. In this case, instead of determining the ON/OFF of each of the plurality of illumination lights, the lighting controller 12 may determine the illumination intensity of each of plurality of illumination lights so that at least a portion of a part of the runways in the automated valet parking lot corresponding to the travel route is illuminated more brightly than the other part.
(2) The lighting apparatus 15 may have a plurality of lights for illumination, each of which can change illumination color. In this case, instead of determining the ON/OFF of each of the plurality of lights for illumination, the lighting controller 12 may determine the illumination color of each of plurality of lights for illumination so that at least a portion of a part of the runways in the automated valet parking lot corresponding to the travel route is illuminated with light in one color and the other part is illuminated with light in a different color from the one color. The illumination color of the lights that illuminate at least a portion of the part corresponding to the travel route is desirably a warning color, such as, for example, red and yellow.
(3) The lighting apparatus 15 may have one or more lights for illumination or laser light sources, each of which (is of a so-called swing type) can change an optical axis angle. In this case, instead of determining the ON/OFF of each light for illumination, the lighting controller 12 may control one or more lights for illumination or laser light sources so that an illumination range of light or laser light moves along the travel route on the part of the runways in the automated valet parking lot corresponding to the travel route.
(4) The lighting apparatus 15 may have a plurality of guide lights placed along the runways in the automated valet parking. The plurality of guide lights may be placed on the runways or by the runways, or may be buried in the runways. In this case, the lighting controller 12 may turn on or blink the guide lights placed in at least a portion of a part of the runways in the automated valet parking lot corresponding to the travel route, and may turn off the guide lights placed in the other part of the runways other than the corresponding part. Alternatively, the lighting controller 12 may enable the color of the guide lights placed in at least a portion of the part corresponding to the travel route to be different from the color of the guide lights placed in the other part.
(5) The lighting apparatus 15 may have a surface light emitting panel provided in the runways in the automated valet parking lot. In this case, the lighting controller 12 may allow the light emitting of the surface light emitting panel provided in at least a portion of a part of the runways in the automated valet parking lot corresponding to the travel route, and may not allow the light emitting of the surface light emitting panel provided in the other part of the runways other than the corresponding part. Alternatively, the lighting controller 12 may enable a light emitting aspect (e.g., color, a light emitting pattern, etc.) of the surface light emitting panel placed in at least a portion of the part corresponding to the travel route to be different from a light emitting aspect of the surface light emitting panel placed in the other part.
(6) The lighting apparatus 15 may have a projector. In this case, the lighting controller 12 may control the projector to project an image including characters, such as, for example, “Caution. Vehicle Approaching”, and an image illustrating an icon indicating the passage of the autonomous vehicle 20, in at least a portion of a part of the runways in the automated valet parking lot corresponding to the travel route.
(7) The lighting controller 12 may determine whether or not there is a pedestrian in the automated valet parking lot on the basis of the detection results of the infrastructure sensor 14. If it is determined that there is the pedestrian in the automated valet parking lot, the lighting controller 12 may perform the step S103 described above. On the other hand, if it is determined that there is no pedestrian in the automated valet parking lot, the lighting controller 12 may turn on or turn off all the plurality of illumination lights provided for the lighting apparatus 15.

Various aspects of embodiments of the present disclosure derived from the embodiment and the modified examples explained above will be explained hereinafter.

A parking system according to an aspect of embodiments of the present disclosure is a parking system configured to manage driving of an autonomous vehicle in a parking lot, which has a parking section including a plurality of parking spaces and runways for vehicle passage, the parking system provided with: an acquirer configured to obtain route information indicating a route on which the autonomous vehicle travels in the parking lot; and an effect applier configured to apply a visual effect to at least a part of the runways so as to visually distinguish between a part of the runways corresponding to the route indicated by the route information and the other part of the runways other than the corresponding part, on the basis of the route information.

In the embodiment described above, the “valet parking apparatus 10” corresponds to an example of the “parking system”. The “route generation arithmetic unit 11” corresponds to the “acquirer”. The “lighting controller 12” and the “lighting apparatus 15” correspond to an example of the “effect applier”.

In the parking system, the visual effect is applied to at least a portion of the runways by the effect applier so as to visually distinguish between the part of the runways in the parking lot corresponding to the route on which the autonomous vehicle travels and the other part of the runways other than the corresponding part. Thus, humans who are around the autonomous vehicle can know a travel route (i.e., a future behavior) of the autonomous vehicle and a safely walkable part, by virtue of the visual effect. Therefore, according to the parking system, it is possible to suppress the anxiety of the humans who are around the traveling autonomous vehicle.

The “visual effect” may mean a phenomenon that has visual appeal for the humans. The expression of “applying the visual effect” may mean changing visual information obtained by the humans (e.g., appearance). Specific examples of the “visual effect” may be the use of light (e.g., changing brightness, changing color, etc.), the use of a mechanism (e.g., storing a fence, a pole, or the like in the ground, or making them appear on the ground, opening/closing a crossing gate mounted between the runways for vehicles and a pedestrian passage, etc.), or the like.

The effect applier may apply the visual effect to at least a portion of the corresponding part (i.e., the part of the runways corresponding to the route indicated by the route information) and may not apply the visual effect to the other part (i.e., the other part of the runways other than the corresponding part), by which the humans (who are particularly the humans around the autonomous vehicle) may visually recognize a difference between the corresponding part and the other part. Alternatively, the effect applier may apply the visual effect to at least a portion of the other part and may not apply the visual effect to the corresponding part, by which the humans may visually recognize the difference between the corresponding part and the other part. Alternatively, the effect applier may apply the visual effect to at least a portion of the corresponding part and to at least a portion of the other part, by which the humans may visually recognize the difference between the corresponding part and the other part.

In an aspect of the parking system, the effect applier has one or more lights mounted in the parking lot, and the effect applier is configured to enable an illumination aspect of at least a portion of the corresponding part to be different from an illumination aspect of the other part, by controlling the one or more lights, as the visual effect. According to this aspect, the visual effect can be applied, relatively easily.

In this case, the effect applier is configured to illuminate at least a portion of the corresponding part more brightly than the other part, by controlling the one or more lights, as the visual effect. By virtue of such a configuration, the illumination aspect of at least a portion of the corresponding part is enabled to be different from the illumination aspect of the other part, relatively easily.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A parking system configured to manage driving of an autonomous vehicle in a parking lot, which has a parking section including a plurality of parking spaces and runways for vehicle passage, said parking system comprising:
an acquirer configured to obtain route information indicating a route on which the autonomous vehicle travels in the parking lot; and
an effect applier configured to apply a visual effect to at least a part of the runways so as to visually distinguish between a part of the runways corresponding to the route indicated by the route information and the other part of the runways other than the corresponding part, on the basis of the route information.

2. The parking system according to claim 1, wherein
said effect applier has one or more lights mounted in the parking lot, and
said effect applier is configured to enable an illumination aspect of at least a portion of the corresponding part to be different from an illumination aspect of the other part, by controlling the one or more lights, as the visual effect.

3. The parking system according to claim 2, wherein said effect applier is configured to illuminate at least a portion of the corresponding part more brightly than the other part, by controlling the one or more lights, as the visual effect.
